(19) United States
(12) Patent Application Publication
(10) Pub. No.: US 2009/0127230 A1
(43) Pub. Date: May 21, 2009

(54) SWITCHING DEVICE FOR DIRECT-CURRENT APPLICATIONS

(75) Inventors: Gerd Schmitz, Niederkassel (DE); Volker Lang, Bonn (DE); Wolfgang Kremers, Bonn (DE); Lothar Winzen, Unkel (DE)

Correspondence Address: DARBY & DARBY P.C., P.O. BOX 770, Church Street Station, New York, NY, 10008-0770, US

(73) Assignee: Moeller GmbH, Bonn (DE)

(21) Appl. No.: 12/271,672

(22) Filed: Nov. 14, 2008

(30) Foreign Application Priority Data
Nov. 17, 2007 (DE) 10 2007 054 960.3

(51) Int. Cl. H01H 9/42

(52) U.S. Cl. 218/145

(57) ABSTRACT

A switching device for direct-current applications including a housing, and at least three current paths. Each current path includes a respective movable switching contact element, a respective stationary switching contact element, and a respective air break between the respective movable and stationary contact elements. Each movable switching contact element is movable into a closed position and into an open position. The switching device includes a quenching capacitor connected in parallel to the respective at least one air break of a first of the current paths and configured to at least one of prevent the formation of an arc and quench an arc formed therealong. The quenching capacitor is not coupled to a second of the current paths. The second current path is couplable in series to the first current path.

### CROSS REFERENCE TO PRIOR APPLICATIONS

Priority is claimed to German Patent Application DE 10 2007 054 960.3, filed Nov. 17, 2007, the entire disclosure of which is incorporated by reference herein.

### FIELD

The present invention relates to a switching device for direct-current applications, which is built employing components of switching devices for alternating-current applications such as, for example, safety cutouts, circuit-breakers, load-break switches and residual-current protectors.

### BACKGROUND

In order to switch off short-circuit currents in secondary distribution systems, for the most part switching devices are employed that have several current paths which, in turn, encompass stationary and movable switching contact elements. Here, the movable switching contact elements can be jointly moved between a closed position, in which the movable and stationary switching contact elements that are associated with each other make contact with each other, and an open position, in which an air break is formed between each of the movable and stationary switching contact elements that are associated with each other. As soon as the switching contact elements are moved under load—that is to say, are moved under a current flow—into the open position, (breaking) arcs are created along the air breaks. The duration of the arcs determines the switching time since the current flow between the switching contact elements is maintained. Moreover, the arcs release a large quantity of heat that leads to thermal destruction of the switching contact elements and thus to a shortening of the service life of the switching device. Consequently, there is a need to quench the arcs as quickly as possible, which can be done by arc-quenching devices such as, for example, arc splitters, arc-quenching plates or deion plates. These quenching devices split the arcs into individual partial arcs; the arcs are reliably quenched when the arc voltages are higher than the driving voltages.

For alternating-current applications, the quenching of the arcs is facilitated in that the current has a natural zero passage. When high (short-circuit) currents have to be switched off, however, an arc-back can occur after the zero passage; in the case of high currents, such a large self-magnetic field is generated that the arcs are automatically deflected towards the arc-quenching devices and are ultimately quenched.

When it comes to switching devices for direct-current applications, no automatic interruption of the arc occurs as is the case with the zero passage of alternating current. Consequently, for direct-current applications, so-called blow-out magnets are employed that generate a magnetic field whose strength and orientation exert a deflecting force (Lorentz force) on the arcs, thus deflecting the arcs towards the arc-quenching devices. The arcs are stretched, cooled and split into partial arcs in the arc-quenching devices, as a result of which they are quenched.

Switching devices of the above-mentioned type for alternating-current applications are described, for example, in DE 103 52 934 B4, DE 102 12 948 B4, DE 20 2005 007 878 U1, EP 1 594 148 A1, EP 0 980 085 B1 and EP 0 217 106 B1.

At the present time, the market for switching devices is broken down into alternating-current switching devices—which are normally manufactured as one-pole or two-pole switching devices in very large production runs—and into direct-current switching devices, which are usually manufactured as one-pole or two-pole switching devices in relatively small production runs. The reasons for this are their different areas of application and the different physics of arc quenching.

Whereas in the past decades direct-current switching devices have actually been something of a niche product, the introduction of alternative sources of energy and especially of solar energy has recently raised the demand for inexpensive direct-current switching devices with isolating properties in the low and medium current ranges. This calls for switching capacities of up to 60 A at about 1000 V of direct voltage. This switching capacity cannot be provided at the present time by conventional switching devices for alternating-current applications (for instance, motor circuit-breakers, contactors and the like) since the quenching devices have not been designed for these applications. The reason for this is, generally, the relatively small deflection force (Lorentz force) exerted on the arcs in case of alternating-current switching devices in the low and medium current ranges, which leads to a relatively long-lasting arc between the contacts of the current paths, with a correspondingly high contact erosion, or to a considerable thermal load on the switching device.

When it comes to one-pole direct-current devices such as, for example, a miniature relay, typically the risk of arc formation is minimized with a capacitor connected in parallel to the current path or to the air break of the current path. This configuration, however, is generally only employed when low direct currents need to be switched. A drawback of the capacitor configuration, however, is that the current path loses its isolating property because the capacitor does not constitute a reliable air break or else its charge is impermissibly high so that it cannot generate an air break according to, for example, European standard EN 60947-3. Consequently, current path-air breaks to which a capacitor is connected in parallel are referred to as “opening breaks”. However, the term “air break” will be used throughout below, even if a capacitor is connected in parallel to such an air break.

### SUMMARY

It is an aspect of the present invention to provide cost-effectively produced switching devices with a direct-current switch-off capability and a direct-current isolating function.

In an embodiment, the present invention provides a switching device for direct-current applications including a housing, and at least three current paths disposed in the housing. Each current path includes a respective movable switching contact element, a respective at least one stationary switching contact element, and a respective at least one air break between the respective movable and stationary contact elements. Each movable switching contact element is movable into a closed position so as to contact the respective at least one stationary switching element and into an open position so as to form the respective at least one air break. The movable switching contact elements are movable simultaneously between the open position and the closed position. The switching device includes a quenching capacitor connected in parallel to the respective at least one air break of a first of the current paths and configured to at least one of prevent a formation of an arc and quench an arc formed therealong. The quenching capacitor is not coupled to a second of the current paths. The second current path is couplable in series to the first current path.

### BRIEF DESCRIPTION OF THE DRAWINGS

The present invention is described in greater depth below on the basis of several embodiments and making reference to the drawing. In the figures:

FIG. 1 shows an exemplary capacitive configuration of a three-pole alternating-current switching device for use as a direct-current switching device with a reliable, two-pole isolation of the direct-current circuit in accordance with an embodiment of the present invention;

FIG. 2 shows an exemplary capacitive configuration of a three-pole alternating-current switching device for use as a direct-current switching device with a reliable isolation of the direct-current circuit in one pole, whereby both poles are switched by the switching device in accordance with an embodiment of the present invention; and

FIG. 3 shows an exemplary capacitive configuration of a three-pole alternating-current switching device for use as a direct-current switching device with a reliable isolation of the direct-current circuit in one pole, whereby the switching device only switches one of the two poles of the direct-current circuit in accordance with an embodiment of the present invention.

### DETAILED DESCRIPTION

An embodiment of the present invention provides a switching device for direct-current applications that includes
a housing,
at least three current paths arranged in the housing, said paths being divided into a first group having at least one first current path, and into a second group having at least one second current path, whereby each current path has a movable switching contact element and at least one stationary switching contact element associated with it, and at least one air break, whereby each movable switching contact element can be moved into a closed position in order to contact the stationary switching contact element associated with it, and into an open position in order to form the air break between the movable switching contact element and the stationary switching contact element, and all of the movable switching contact elements can be moved together out of their open position into their closed position and vice versa,
a quenching capacitor to prevent the formation of an arc and/or to quench an arc that could potentially form along at least one of the air breaks,
whereby the quenching capacitor is connected in parallel to at least one air break of the at least one first current path, and the at least one second current path is free of a quenching capacitor connected in parallel, and
whereby the at least one second current path can be connected in series to the at least one first current path.

The starting point for the switching device according to the present invention having a direct-current switching capability is a conventional multi-pole alternating-current switching device that has a capacitive configuration. A multi-pole alternating-current switching device has several current paths (usually at least three) that are arranged next to each other in a housing and that can be simultaneously opened and closed. Each current path has a movable switching contact element and at least one stationary switching contact element associated with the appertaining movable switching contact element. In the open position of each current path, an air break is formed between the two switching contact elements along which an arc can be generated if the switching device is switched off under load, a procedure that can cause damage to the switching device. An aspect of the present invention provides a conventional multi-pole alternating-current switching device (such as, for instance, a motor circuit-breaker) with a capacitor in such a way that, on the one hand, the switching arc is reliably quenched within a short period of time and, on the other hand, the isolating property of the switching device is retained. This is achieved according to the present invention in that the at least three current paths are divided into a first current path group and into a second current path group, each comprising at least one current path. A quenching capacitor is then connected in parallel to the air break of the first current path or current paths (current path of the first current path group). Furthermore, the at least one current path of the second current path group can be connected in series to the first current path. Therefore, in the configuration according to an embodiment of the present invention, the multi-pole alternating-current switching device has at least one first current path and at least one second current path, which are connected in series, which can be done either directly, in other words, inside the switching device or through the external configuration of the switching device, or else through the configuration of the switching device inside a direct-current circuit, for instance, via the consumer connected to the switching device; the at least one second current path, the consumer and the at least one first current path are then connected in series. In addition, the at least one first current path of the quenching capacitor is connected in parallel to the air break, which is why, to put it more precisely, the air break of this current path is an opening break, since the isolating function of the air break with a quenching capacitor connected in parallel required, for example, according to European standard EN 60947-3, cannot be realized. Below, however, for the sake of simplicity, the term air break of the current path will be used, irrespective of whether a quenching capacitor is connected in parallel to an air break.

Thus, the quenching capacitor (reliably) prevents the occurrence of an arc and/or quenches the arc over the air break of the at least one first current path within a very short period of time, as a result of which the current flow through the series connection of both current paths is interrupted, and so is the entire direct-current circuit if the switching device is part of a direct-current circuit. The air break of the at least one second current path ensures the requisite isolating function, as a result of which the switching device so configured now has a direct-current switching capacity in the low to medium current ranges while also ensuring the isolating function. In this manner, it has thus been possible to optimize a conventional three-pole or four-pole or multi-pole alternating-current switching device in such a way that it now offers a direct-current switching capability and a direct-current isolating function.

In accordance with aspects of the present invention, it is possible, for example, to use a conventional three-pole alternating-current switching device for a two-pole isolation of a direct-current circuit. In this case, the quenching capacitor is connected in parallel to one of the three current paths (first current path), while the other two current paths (second current paths) at first remain unchanged. Moreover, one of the two second current paths is connected in series to the first current path, which is either done by appropriately connecting the two current paths directly or else when the switching device is technically integrated into the direct-current circuit. The air break of the second current path that is connected in series to the first current path serves to isolate one pole of the direct-current circuit, while the air break of the remaining second current path serves to isolate the other pole of the direct-current switching device (three-pole switch with a reliable two-pole isolation of the direct-current circuit).

It is likewise possible to employ a conventional three-pole switching device for a reliable one-pole separation for a direct-current circuit. In this case, the three current paths are then connected in series, whereby a quenching capacitor is connected in parallel to the series connection of two current paths. As a result, these two current paths connected in series form two first current paths of the switching device. The remaining third current path (second current path) is then connected in series to the two first current paths (three-pole switch with a reliable isolation of the direct-current circuit in one of its two poles).

The parallel connection of the quenching capacitor to several (first) current paths connected in series has the advantage that the capacitance of the capacitor can be reduced owing to the greater voltage strength recovery of the various current paths.

According to an advantageous embodiment of the present invention, it is also provided that a discharge resistor is connected in parallel to the quenching capacitor. This discharge resistor ensures that the quenching capacitor is discharged when the switching device is in its switched-off state, so as to prevent a “hard” discharge of the capacitor via the switching contact elements once the switching device is switched back on.

Conventional multi-pole alternating-current switching devices are provided with current paths that each have a movable switching contact element and two stationary switching contact elements situated opposite from each other. In the closed state, the movable switching contact element connects the two stationary switching contact elements. Such a current path includes two air breaks along which arcs can form. When such an alternating-current switching device is used, the quenching capacitor having the capacitive configuration according to an embodiment of the present invention is then connected in parallel to the series connection of the two air breaks of a current path.

The joint closing of all of the current paths in conventional multi-pole alternating-current switching devices is usually done by actuating a so-called breaker latching mechanism, either manually or by actuating an actuating element (for instance, a knob switch) in some other manner. In this process, the movable switching contact elements of all of the current paths are locked in their closed positions by the breaker latching mechanism which, depending on the design of the switching device, for instance, as a circuit-breaker, is switched off in response to various events (for example, excessive current due to a short-circuit), so that the current paths are simultaneously switched to their open positions.

Consequently, a feature of the present invention is the use of a switching device designed for alternating-current applications including
a housing, and
at least three current paths arranged in the housing, said paths being divided into a first group having at least one first current path, and into a second group having at least one second current path, whereby each current path has a movable switching contact element and at least one stationary switching contact element associated with it, and at least one air break, whereby each movable switching contact element can be moved into a closed position in order to contact the stationary switching contact element associated with it, and into an open position in order to form the air break between the movable switching contact element and the stationary switching contact element, and all of the movable switching contact elements can be moved together out of their open position into their closed position and vice versa,
   as a switching device for direct-current applications, in which
a quenching capacitor is connected in parallel to at least one air break of the at least one first current path, and the at least one second current path remains free of a quenching capacitor, and the at least one second current path can be connected in series to the at least one first current path.

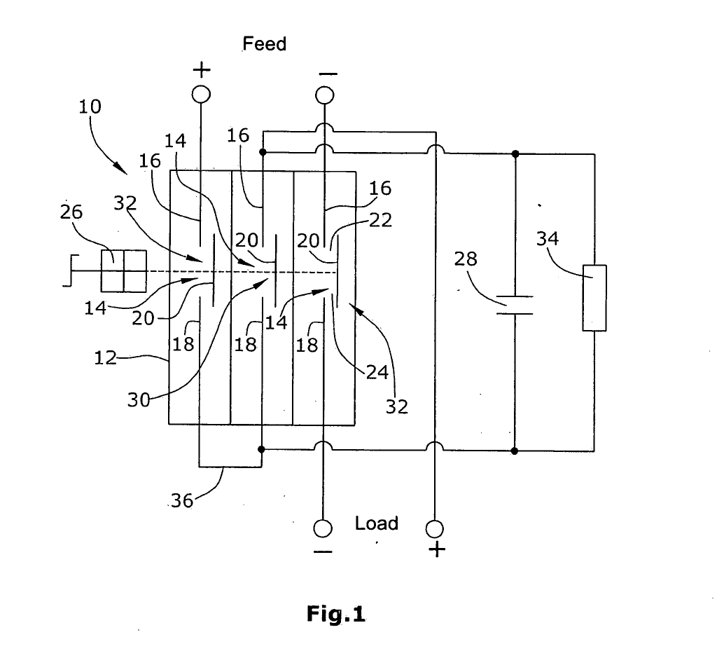

FIG. 1 shows a first embodiment according to the present invention of a switching device 10 that is designed for alternating-current applications and that is configured in such a way that this switching device 10 can be used to isolate direct-current circuits. The switching device 10 has a schematically depicted housing 12 that has three current paths 14 in this embodiment. Each current path 14 includes two stationary switching contact elements 16, 18 that can each be electrically connected to or disconnected from each other via a movable switching contact element 20. Therefore, in the open state of the movable switching contact elements 20, two air breaks 22, 24 per current path 14 are formed. The movable switching contact elements 20 can be moved between the open and closed positions by a breaker latching mechanism 26 (shared actuating device).

In the exemplary embodiment shown in FIG. 1, one of the three current paths 14, namely, the center one of the three current paths 14, is provided with a quenching capacitor 28 that is connected in parallel to the current path 14. This current path 14 will be referred to below as the first current path 30, while the two other current paths 14 can be designated as second current paths 32. These two second current paths 32 do not have any quenching capacitors connected in parallel. As can be seen in FIG. 1, a (discharge) resistor 34 is connected in parallel to the quenching capacitor 28. One of the second current paths 32 and the first current path 30 are connected to each other in series through an external configuration (see electric connection 36).

If the switching device 10 thus configured is now connected to a direct-current circuit, it then lies between a feed (for instance, a solar installation) and a load or a consumer. Here, one of the poles (the minus pole in this embodiment) of the direct-current circuit is connected via one of the two second current paths 32, namely, the second current path 32 that is not connected in series to the first current path 30. The other pole (the plus pole in this embodiment) of the direct-current circuit is connected to the series connection consisting of the other second current path 32 and the first current path 30. Consequently, two-pole isolation of the direct-current circuit is possible, a process in which a reliable quenching of an arc is achieved by the quenching capacitor 28 and the air breaks of the second current path 32 connected in series to the first current path 30 provide the isolating function. When the switching device 10 is in its switched-off state, both poles of the direct-current circuit are isolated, whereby the air breaks are formed by the open second current paths 32, which are free of a quenching capacitor connected in parallel.

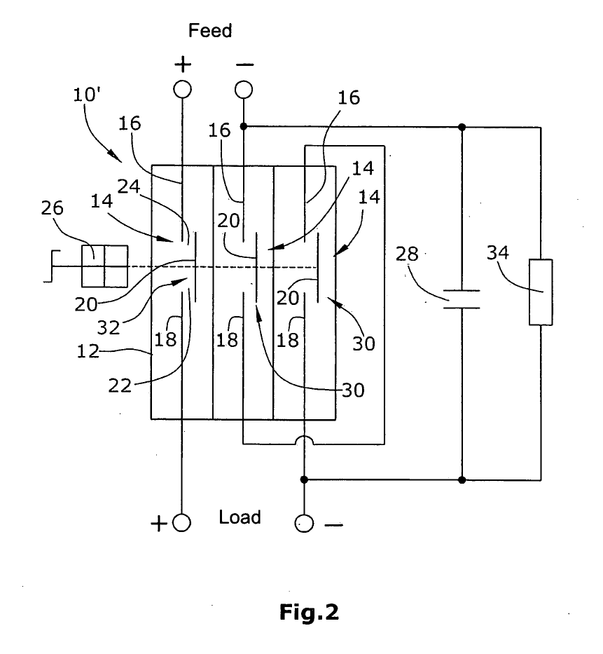

FIG. 2 shows a second embodiment according to the present invention of a capacitive configuration of a switching device 10′ for alternating-current applications used to isolate direct-current circuits. To the extent that individual components of the configuration shown in FIG. 2 are structurally the same or have the same function as the individual components shown in FIG. 1, they have been provided with the same reference numerals in FIG. 2.

In the embodiment shown in FIG. 2, two of the three current paths 14 are connected to each other in series. The quenching capacitor 28 with the parallel-connected discharge resistor 34 is connected in parallel to these two current paths 14. Therefore, the two current paths 14 connected in series are two first current paths 30. The third current path then takes over the function of the pure isolator (second current path 32) and is connected in series to the two first current paths 30 via the load. The isolation of a direct-current circuit by means of the switching device 10′ shown in FIG. 2 takes place at one pole—in this embodiment by physically separating the plus pole—while the second pole—the minus pole in this embodiment—has the quenching capacitor 28 in the switched-on state.

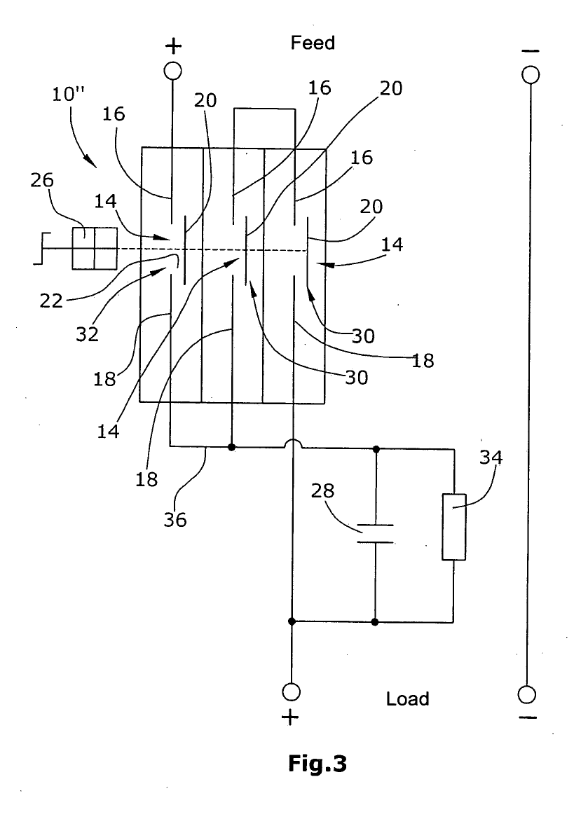

FIG. 3 shows another embodiment of a capacitive configuration of an alternating-current switching device 10″ to be used to switch off direct-current with an isolating function according to the present invention. To the extent that individual components of the configuration shown in FIG. 3 are structurally the same or have the same function as the individual components shown in FIG. 1, they have been provided with the same reference numerals in FIG. 3.

As was the case in the embodiment shown in FIG. 2, in the embodiment in FIG. 3, the quenching capacitor 28 with the parallel-connected discharge resistor 34 is likewise connected in parallel to the series connection of two (first) current paths 30. The remaining third current path, which takes over the function of the above-described current path 32 of the second group, is connected in series to this parallel connection consisting of the quenching capacitor 28, the discharge resistor 34 and the two first current paths 30 situated one behind the other. In other words, the second current path 32 shown in FIG. 3 takes over the physical isolating function in one of the two poles (the plus pole in this embodiment) of the direct-current circuit. In this embodiment, the minus pole does not have a current path but, if a four-pole conventional alternating-current switching device is used, could be realized by the fourth current path that is then still available.

Generally speaking, it should be pointed out that the embodiments described above as well as the present invention in its entirety can also be realized with a four-pole alternating-current switching device or with an alternating-current switching device having an even higher numbers of poles.

In the embodiments shown in FIGS. 2 and 3, the quenching capacitor 32 is connected in parallel to several first current paths 30 connected in series. As a result, the capacitance of the capacitor can be reduced owing to the greater voltage strength recovery of the multiple current paths.

The present invention is not limited to the embodiments described herein; reference should be had to the appended claims.

1. A switching device for direct-current applications, comprising:
a housing;
at least three current paths disposed in the housing, each current path including a respective movable switching contact element, a respective at least one stationary switching contact element, and a respective at least one air break between the respective movable and stationary contact elements, each movable switching contact element being movable into a closed position so as to contact the respective at least one stationary switching element and into an open position so as to form the respective at least one air break, the movable switching contact elements being movable simultaneously between the open position and the closed position; and
a quenching capacitor connected in parallel to the respective at least one air break of a first of the current paths and configured to at least one of prevent a formation of an arc and quench an arc formed therealong,
wherein the quenching capacitor is not coupled to a second of the current paths, and
wherein the second current path is couplable in series to the first current path.

2. The switching device as recited in claim 1, further comprising a discharge resistor coupled in parallel to the quenching capacitor.

3. The switching device as recited in claim 1, wherein each of the at least one stationary switching contact elements includes a first and a second stationary switching contact element disposed opposite each other and connectable by the respective movable switching contact element when the respective movable switching contact element is in the closed position,
wherein each of the at least one air break includes a respective first air break formed between the first stationary switching contact element and the movable switching contact element and a second air break formed between the second stationary switching contact element and then respective movable switching contact element.

4. The switching device as recited in claim 2, wherein each of the at least one stationary switching contact elements includes a first and a second stationary switching contact element disposed opposite each other and connectable by the respective movable switching contact element when the respective movable switching contact element is in the closed position,
wherein each of the at least one air break includes a respective first air break formed between the first stationary switching contact element and the movable switching contact element and a second air break formed between the second stationary switching contact element and then respective movable switching contact element.

5. The switching device as recited in claim 1, further comprising a breaker latch configured to simultaneously actuate the movable switching contact elements and lock the movable switching contact elements in the closed position.

6. The switching device as recited in claim 2, further comprising a breaker latch configured to simultaneously actuate the movable switching contact elements and lock the movable switching contact elements in the closed position.

7. The switching device as recited in claim 3, further comprising a breaker latch configured to simultaneously actuate the movable switching contact elements and lock the movable switching contact elements in the closed position.

8. The switching device as recited in claim 1, wherein the quenching capacitor is connected in parallel to the respective air break of a third of the current paths and is configured to at least one of prevent the formation of an arc and quench an arc formed therealong, and wherein first current path is connected in series to the third current path and the quenching capacitor is coupled to the series connection of the first and third current paths.

9. The switching device as recited in claim 2, wherein the quenching capacitor is connected in parallel to the respective air break of a third of the current paths and is configured to at least one of prevent the formation of an arc and quench an arc formed therealong, and wherein first current path is connected in series to the third current path and the quenching capacitor is coupled to the series connection of the first and third current paths.

10. The switching device as recited in claim 3, wherein the quenching capacitor is connected in parallel to the respective air break of a third of the current paths and is configured to at least one of prevent the formation of an arc and quench an arc formed therealong, and wherein first current path is connected in series to the third current path and the quenching capacitor is coupled to the series connection of the first and third current paths.

11. The switching device as recited in claim 5, wherein the quenching capacitor is connected in parallel to the respective air break of a third of the current paths and is configured to at least one of prevent the formation of an arc and quench an arc formed therealong, and wherein first current path is connected in series to the third current path and the quenching capacitor is coupled to the series connection of the first and third current paths.

12. The switching device as recited in claim 1, wherein the quenching capacitor is not connected to a fourth of the current paths, and wherein the fourth current path is connected in series to the first current path.

13. The switching device as recited in claim 2, wherein the quenching capacitor is not connected to a fourth of the current paths, and wherein the fourth current path is connected in series to the first current path.

14. The switching device as recited in claim 3, wherein the quenching capacitor is not connected to a fourth of the current paths, and wherein the fourth current path is connected in series to the first current path.

15. The switching device as recited in claim 5, wherein the quenching capacitor is not connected to a fourth of the current paths, and wherein the fourth current path is connected in series to the first current path.

16. A switching device for direct-current applications, comprising:
a switching device for alternating-current applications, including:
a housing; and
at least three current paths disposed in the housing, each current path including a respective movable switching contact element, a respective at least one stationary switching contact element, and a respective at least one air break between the respective movable and stationary contact elements, each movable switching contact element being movable into a closed position so as to contact the respective at least one stationary switching element and into an open position so as to form the respective at least one air break, the movable switching contact elements being movable simultaneously between the open position and the closed position, and wherein the at least three current paths are divided into a first group of current paths and a second group of current paths; and
a quenching capacitor connected in parallel to the respective at least one air break of a first of the current paths and configured to at least one of prevent a formation of an arc and quench an arc formed therealong,
wherein the quenching capacitor is not coupled to a second of the current paths, and
wherein the second current path is couplable in series to the first current path.
